(19) United States
(12) Patent Application Publication
(10) Pub. No.: US 2010/0189906 A1
(43) Pub. Date: Jul. 29, 2010

(54) PROCESS FOR THE FORMATION OF MULTILAYER COATING FILM AND PROCESS FOR THE PRODUCTION OF COATED MEMBERS

(75) Inventors: Yasuhiro Kume, Tokyo (JP); Masaki Takahashi, Tokyo (JP); Satoru Shiratori, Tokyo (JP); Shinji Noda, Tokyo (JP); Makoto Takayanagi, Tokyo (JP); Tatsuo Minami, Tokyo (JP); Yoshiharu Komatsu, Tokyo (JP); Daisuke Nakazono, Tochigi (JP); Kazuo Igarashi, Saitama (JP); Satoru Ihara, Saitama (JP)

Correspondence Address: RANKIN, HILL & CLARK LLP, 38210 GLENN AVENUE, WILLOUGHBY, OH, 44094-7808, US

(73) Assignee: HONDA MOTOR CO., LTD., Tokyo (JP)

(21) Appl. No.: 12/676,073

(22) PCT Filed: Sep. 3, 2007
(86) PCT No.: PCT/JP2007/067155

§ 371 Date: Mar. 2, 2010

(51) Int. Cl. B05D 1/38; B05D 1/36; B05D 3/02

(52) U.S. Cl. 427/379; 427/372.2

(57) ABSTRACT

A three-coat one-bake type coating process for forming a multilayer coating film which attains high efficiency and brings about an excellent finished appearance. A three-coat one-bake type coating process includes applying an intermediate coating material, applying a finish base coating material, applying a clear topcoating material, and drying, wherein a two-package type coating material containing an isocyanate compound as the crosslinking agent is used as the intermediate coating material, whereby the surface fluidity of the intermediate coating is improved to make the coating surface smooth and the mixing of the intermediate coating with an upper layer and/or the volume shrinkage of the intermediate coating due to the component eliminated by curing are inhibited to give coated members having an excellent finished appearance.

### TECHNICAL FIELD

The present invention relates to a method for forming a multilayer coating film and a method for manufacturing a coated article using the method for forming a multilayer coating film. In particular, the invention relates to a method for forming a multilayer coating film that is suitably used for coating an outer panel of a vehicle body.

### BACKGROUND ART

Conventionally, a three-coat two-bake (3C2B) coating process has often been employed for coating outer panels of a vehicle body. In a typical 3C2B coating method, an article to be coated that is given a primer coating such as electrocoating is subjected to a step of applying an intermediate coating material, a step of drying, a step of applying a base top coating material, a step of preheating, a step of applying a top clear-coat material, and a step of drying in succession to form a multilayer coating film. This coating method is called three-coat two-bake (3C2B) since it includes the application of three types of coating materials with two types of drying steps to an article to be coated that has undergone a coating pretreatment process, electrocoating, and electrocoat baking. The coating method can produce coated articles with excellent finished appearance, and thus is suitably used for coating outer panels, etc. of a vehicle body. However, the 3C2B coating system is not so efficient, due to the long coating steps thereof.

A three-coat one-bake (3C1B) process can be exemplified as a more efficient coating process; however, there has been a problem in that the coating materials used in the conventional 3C2B coating process will result in too thick a wet film after top coating, thereby generating sags and blisters, which lower workability when used in the 3C1B process. For this reason, research has recently been made into a variety of 3C1B coating methods for achieving excellent finished appearance.

For example, Patent Document 1 proposes a 3C1B coating method in which an intermediate coating material containing hygroscopic particles for absorbing the solvent component of a top coating material is applied to the surface of a primer coating film to form an uncured intermediate coating film. The uncured intermediate coating film is then coated with the top coating material, and the uncured intermediate coating material and top coating material are cured at the same time. According to this coating method, since the solvent contained in the top coating layer is absorbed by the hygroscopic particles contained in the intermediate coating layer, it is said that the absorption can rapidly increase the NV (Non-Volatile) of the spreading top coating layer, thereby preventing the solvent in the top coating material from permeating into the intermediate coating layer. It is also said that the intermediate coating layer and the top coating layer will not generate a mixture at the interface, which can improve the smoothness of the top coating film and prevent the occurrence of sagging and other troubles.

Patent Document 2 proposes a coating method in which an intermediate coating material is applied to form an uncured intermediate coating film, and a curing catalyst for promoting the curing of the uncured intermediate coating layer is then applied before the application of a top coating material. According to this coating method, since the intermediate coating layer cures at least in the surface, it is said that the presence of the surface-hardened film can prevent the solvent in the top coating material from permeating into the intermediate coating layer after the application of the top coating material. It is also said that the intermediate coating layer and the top coating layer will not generate a mixture at the interface, which improves the smoothness of the top coating film.

Patent Document 3 proposes a coating method which includes steps of forming a primer coating film, an intermediate coating film, and a top coating film, respectively, and in which a first intermediate coating material and a second intermediate coating material having different solid concentrations are applied in succession as the intermediate coating material to form a first intermediate coating film and a second intermediate coating film. According to this coating method, it is said that the presence of the difference in solid concentration within the intermediate coating films makes it possible to control the smoothness and volume shrinkage of the intermediate coating films for improved coating clearness when cured.

Patent Document 4 proposes a method for forming a coating film, in which a thermosetting organic solvent-based intermediate coating material (A) that contains a neutralized hydroxyl-containing resin with an acid number of 5 to 100 and a crosslinking agent selected from among a blocked polyisocyanate and amino resin is applied; and then a thermosetting water-based colored top coating material (B) is cured on the uncured coating surface at the same time. It is said that this method for forming a coating film can enhance the smoothness, clearness, luster, and other finish appearances of the coating surface and the adhesion and the like between the two coating layers, prevent the water-based top coating material from running and the like without strict humidity control, prevent mixing of the coating layers, and avoid after-tackiness.

Non-Patent Document 1 proposes a coating method for applying a polyester-melamine type one-part solvent coating material mixed with urethane resin as the intermediate coating material in a three wet-on coating system in which an intermediate coating material, a base top coating material, and a top clear coating material are applied on each other in a wet state without baking. According to this coating method, the coating film improves in viscosity after preheating, and it is said that the uncured intermediate coating film and top coating films consequently have a greater difference in viscosity, which makes it possible to avoid mixing upon the base top coating, thereby providing a coated article superior in finish appearance.

Non-Patent Document 2 proposes a coating method for a three wet-on coating system in which an intermediate coating resin is selected in view of SP value (polarity) and cure rate, and a dispersed acrylic resin is used to control the interface of the intermediate coating film. According to this coating method, a barrier layer is formed on the surface of the intermediate coating film. This is described to prevent mixing at the interface between the intermediate coating film and the base top coating film, providing a coated article of superior finish appearance.

Patent Document 1: Japanese Unexamined Patent Application Publication No. 2005-211875

Patent Document 2: Japanese Unexamined Patent Application Publication No. 2005-193107

Patent Document 3: Japanese Unexamined Patent Application Publication No. 2005-177631

Patent Document 4: Japanese Unexamined Patent Application Publication No. H10-128224

Non-Patent Document 1: Satoshi Kodama, Mitsuhiro Wakuta, Akira Tanahashi, and Mitsugu Endo, “Development of Eco-Friendly Water-based Coating Technology,” Coating Technology, 2005, Vol. 40, pp. 429-439

Non-Patent Document 2: Toshifumi Ogasawara, “Introduction to Three Wet-on Coating,” Japan Coating Technology Association, 2002, Preprints of 2nd Conference, pp. 50-54

### DISCLOSURE OF THE INVENTION

### Problems to be Solved by the Invention

As described above, the 3C1B coating methods disclosed in the foregoing patent documents and non-patent documents primarily use a technique of increasing the viscosity of the intermediate coating film in order to make the intermediate coating film capable of wet coating with the top coating material(s). As a result, with these coating methods, it has been impossible to obtain surface fluidity for the uncured intermediate coating film when baking and curing, and a favorable finish appearance could not be obtained. Thus far, as a means for improving the finish appearance of the multilayer wet coatings, there has generally been a means by which curing is performed successively from the bottom layer; however, applying this technique to a 3C1B coating method is physically impossible. It has, therefore, been desired to develop a 3C1B method for forming a multilayer coating film which can achieve a favorable finish appearance.

The present invention has been achieved in view of the foregoing problems, and an object thereof is to provide: a 3C1B method for forming a multilayer coating film with high efficiency and favorable finish appearance; 4C2B and 5C2B methods for forming a multilayer coating film, including steps of forming many layers of coating film of even higher marketability on the basis of the 3C1B method for forming a multilayer coating film; and methods for manufacturing a coated article, using the 3C1B, 4C2B, and 5C2B methods for forming a multilayer coating film. Another object of the invention is to provide a method for manufacturing a coated article with low CO₂ emissions by conserving energy in order to contribute to the protection of the global environment.

### Means for Solving the Problems

The present inventors have thoroughly researched to solve the foregoing problems. As a result, it was found that the abovementioned problems could be solved through the use of a two-part liquid intermediate coating material containing an isocyanate compound as a crosslinking agent for 3C1B coating steps, and thereby arrived at accomplishing the present invention. More specifically, the present invention provides the following.

In a first aspect of the present invention, a method for forming a multilayer coating film including: a primer coating material coating step of coating a primer coating material onto an article to be coated; an intermediate coating material application step of applying a two-package liquid intermediate coating material containing an isocyanate compound as a crosslinking agent onto the article to be coated that has undergone the primer coating material coating step; a first base top coating material application step of applying a first base top coating material onto the article to be coated that has undergone the intermediate coating material application step; a first clear top coating material application step of applying a first clear top coating material onto the article to be coated that has undergone the first base top coating material application step; and a first drying step of drying the article to be coated that has undergone the first clear top coating material application step.

In a second aspect of the present invention, the method for forming a multilayer coating film as described in the first aspect further includes, between the intermediate coating material application step and the first base top coating material application step, a first preheating step of preheating the article to be coated that has undergone the intermediate coating material application step.

According to a third aspect of the present invention, in the method for forming a multilayer coating film as described in the second aspect, the first preheating step is performed at a preheating temperature higher than or equal to 40° C. and lower than or equal to 100° C.

According to a fourth aspect of the present invention, the method for forming a multilayer coating film as described in any one of the first to third aspects further includes, between the first base top coating material application step and the first clear top coating material application step, a second preheating step of preheating the article to be coated that has undergone the first base top coating material application step.

According to a fifth aspect of the present invention, in the method for forming a multilayer coating film as described in the fourth aspect, the second preheating step is performed at a preheating temperature higher than or equal to 40° C. and lower than or equal to 100° C.

According to a sixth aspect of the present invention, the method for forming a multilayer coating film as described in any one of the first to fifth aspects further includes: after the first drying step, a second clear top coating material application step of applying a second clear top coating material; and a second drying step of drying the article to be coated that has undergone the second clear top coating material application step.

According to a seventh aspect of the present invention, the method for forming a multilayer coating film as described in the sixth aspect further includes: between the first drying step and the second clear top coating material application step, a second base top coating material application step of applying a second base top coating material; and a third preheating step of preheating the article to be coated that has undergone the second base top coating material application step.

According to an eighth aspect of the present invention, in the method for forming a multilayer coating film as described in the seventh aspect, the third preheating step is performed at a preheating temperature higher than or equal to 40° C. and lower than or equal to 100° C.

According to a ninth aspect of the present invention, in the method for forming a multilayer coating film as described in any one of the first to eighth aspects, an anti-chipping primer is applied in the intermediate coating material application step before the intermediate coating material is applied.

According to a tenth aspect of the present invention, in the method for forming a multilayer coating film as described in any one of (1) to (9), an article to be coated that includes a first auxiliary material attached thereto is used as the article to be coated with the primer coating material.

According to an eleventh aspect of the present invention, the method for forming a multilayer coating film as described in any one of the first to tenth aspects further includes, between the primer coating material coating step and the intermediate coating material application step, a step of attaching a second auxiliary material onto the article to be coated that has undergone the primer coating material coating step.

According to a twelfth aspect of the present invention, the method for forming a multilayer coating film as described in any one of the first to eleventh aspects further includes, after the first drying step, a step of attaching a third auxiliary material onto the article to be coated that has undergone the first drying step.

According to a thirteenth aspect of the present invention, in the method for forming a multilayer coating film as described in any one of the first to twelfth aspects, a base and the crosslinking agent of the two-package liquid intermediate coating material containing the isocyanate compound as the crosslinking agent are mixed in the vicinity of a spray gun for spraying the intermediate coating material.

According to a fourteenth aspect of the present invention, in the method for forming a multilayer coating film as described in any one of the first to thirteenth aspects, the article to be coated is an outer panel of a vehicle body.

According to a fifteenth aspect of the present invention, a method for manufacturing a coated article having a multilayer coating film, includes: a primer coating material coating step of coating an article to be coated with a primer coating material; an intermediate coating material application step of applying a two-package liquid intermediate coating material containing an isocyanate compound as a crosslinking agent onto the article to be coated that has undergone the primer coating material coating step; a first base top coating material application step of applying a first base top coating material onto the article to be coated that has undergone the intermediate coating material application step; a first clear top coating material application step of applying a first clear top coating material onto the article to be coated that has undergone the first base top coating material application step; and a first drying step of drying the article to be coated that has undergone the first clear top coating material application step.

According to a sixteenth aspect of the present invention, the method for manufacturing a coated article as described in the fifteenth aspect further includes a second clear top coating material application step of applying a second clear top coating material, after the first drying step; and a second drying step of drying the article to be coated that has undergone the second clear top coating material application step.

According to a seventeenth aspect of the present invention, the method for manufacturing a coated article described in the sixteenth aspect further includes: between the first drying step and the second clear top coating material application step, a second base top coating material application step of applying a second base top coating material; and a third preheating step of preheating the article to be coated that has undergone the second base top coating material application step.

According to an eighteenth aspect of the present invention, in the method for manufacturing a coated article as described in any one of the fifteenth to seventeenth aspects, a base and the crosslinking agent of the two-package liquid intermediate coating material containing the isocyanate compound as the crosslinking agent are mixed in the vicinity of a spray gun for spraying the intermediate coating material.

### EFFECTS OF THE INVENTION

According to the present invention, it is possible to provide: a 3C1B method for forming a multilayer coating film with high efficiency and favorable finish appearance; 4C2B and 5C2B methods for forming a multilayer coating film, including steps of forming many layers of coating film of improved quality on the basis of the 3C1B method for forming a multilayer coating film; and methods for manufacturing a coated article, using the 3C1B, 4C2B, and 5C2B methods for forming a multilayer coating film.

### BRIEF DESCRIPTION OF THE DRAWINGS

FIG. 1 is a flowchart of the method for forming a multilayer coating film according to a first embodiment of the present invention;

FIG. 2A is a diagram for illustrating the mechanism of the method for forming a multilayer coating film;

FIG. 2B is a diagram for illustrating the mechanism of the method for forming a multilayer coating film;

FIG. 2C is a diagram for illustrating the mechanism of the method for forming a multilayer coating film;

FIG. 3A is a diagram for illustrating the mechanism of the method for forming a multilayer coating film;

FIG. 3B is a diagram for illustrating the mechanism of the method for forming a multilayer coating film;

FIG. 3C is a diagram for illustrating the mechanism of the method for forming a multilayer coating film;

FIG. 4 is a chart showing changes in viscosity of multilayer coating films with time;

FIG. 5 is a schematic diagram showing the crosslinking reaction of an intermediate coating film according to the present embodiment;

FIG. 6 is a schematic diagram showing the crosslinking reaction of a conventional intermediate coating film;

FIG. 7 is a schematic block diagram of a two-package liquid mixing type coating apparatus;

FIG. 8 is a flowchart of the method for forming a multilayer coating film according to a modification of the present embodiment;

FIG. 9 is a flowchart of the method for forming a multilayer coating film according to a modification of the present embodiment;

FIG. 10 is a flowchart of the method for forming a multilayer coating film according to a modification of the present embodiment;

FIG. 11 is a flowchart of the method for forming a multilayer coating film according to a modification of the present embodiment;

FIG. 12 is a flowchart of a conventional method for forming a multilayer coating film;

FIG. 13 is a flowchart of the method for forming a multilayer coating film according to a second embodiment of the present invention;

FIG. 14 is a flowchart of the method for forming a multilayer coating film according to a third embodiment of the present invention;

FIG. 15 is a diagram showing the flow of a preferred embodiment for a manufacturing facility for manufacturing coated articles using the method for forming a multilayer coating film according to the present invention;

FIG. 16 is a flowchart of a conventional 4C3B method for forming a multilayer coating film; and

FIG. 17 is a diagram showing the flow of another preferred embodiment of a manufacturing facility for manufacturing coated articles using the method for forming a multilayer coating film according to the present invention.

### PREFERRED MODE FOR CARRYING OUT THE INVENTION

Hereinafter, a preferred first embodiment of the present invention will be described with reference to the drawings.

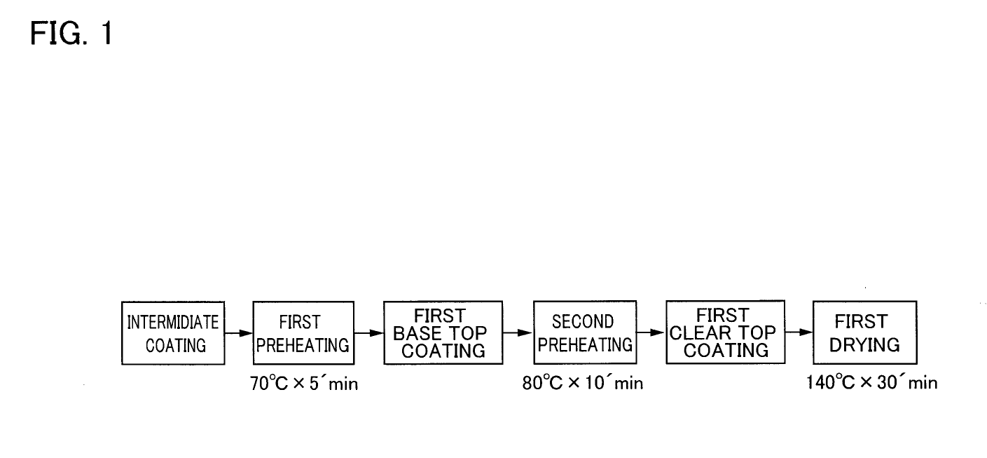

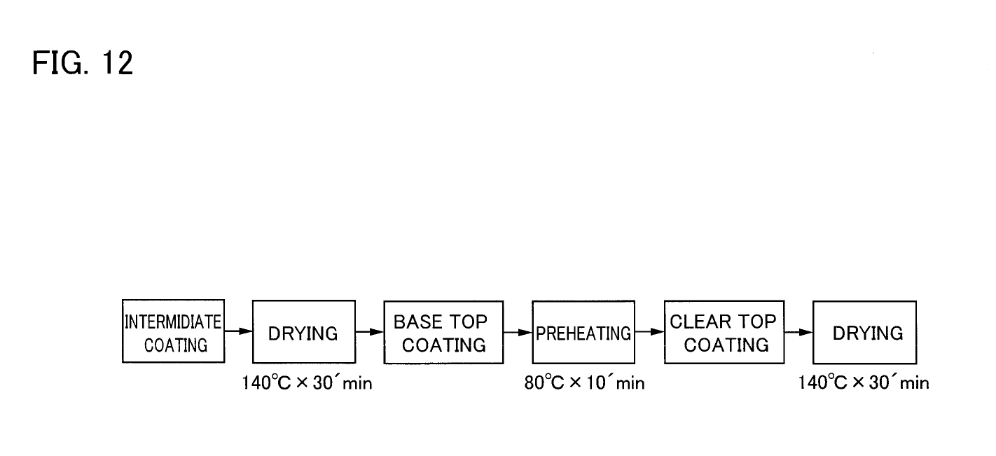

FIG. 1 shows a flow representing an example of the method for forming a multilayer coating film according to the present embodiment. As shown in FIG. 1, the method for forming a multilayer coating film according to the present embodiment is a 3C1B method for forming a multilayer coating layer, and when compared to a conventional 3C2B method for forming a multilayer coating film such as that shown in FIG. 12, the 3C1B method greatly differs in that the drying step is not provided subsequent to the step of applying an intermediate coating material. More specifically, the method for forming a multilayer coating film according to the present embodiment includes: an intermediate coating material application step in which an intermediate coating material is applied to an article to be coated that is given a primer coating such as electrocoating; a first preheating step in which the article to be coated that has undergone the intermediate coating material application step is preheated; a first base top coating material application step in which a first base top coating material is applied; a second preheating step in which the article to be coated that has undergone the first base top coating material application step is preheated; a first clear top coating material application step in which a first clear top coating material is applied; and a first drying step in which the article to be coated that has undergone the first clear top coating material application step is dried.

### Article to be Coated

Examples of the article to be coated in the present embodiment include a metal member, plastic member, and the like that are used for outer panels of a two-wheel or four-wheel vehicle. These members are preferably subjected to pretreatment (surface treatment) such as degreasing and chemical treatment before the application of a primer coating such as electrocoating. According to the method for forming a multilayer coating film related to the present embodiment, since coated articles can be provided having superior finish appearance, application thereof to outer panels of a vehicle body for which a superior finish appearance is particularly desired is possible.

### Step of Applying Intermediate Coating Material

Thus far, although one-package liquid intermediate coating materials containing melamine resin, blocked isocyanate, or the like as a crosslinking agent have been used, in the present manufacturing process, a two-package liquid intermediate coating material is used that contains an isocyanate compound as the crosslinking agent. The intermediate coating material used in this step is thus significantly different from the conventional intermediate coating materials in composition, and the system for curing the intermediate coating film is also different.

Conventionally, there has been a problem of poor finish appearance in a case where the intermediate coating materials used in a 3C2B coating method are employed in a 3C1B coating method. The following three can be considered as possible causes of the deterioration in finish appearance.

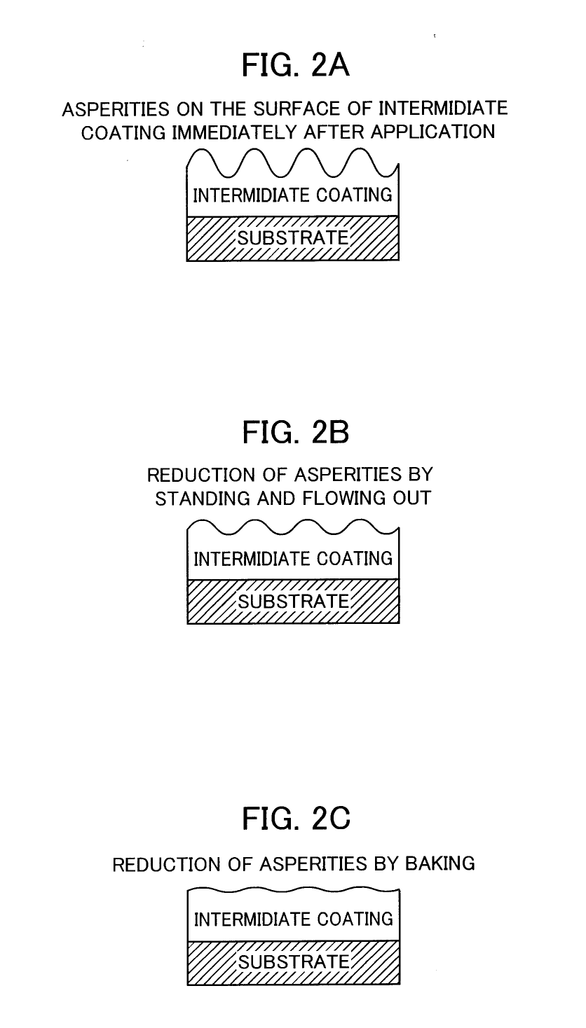

Firstly, one cause that can be given is that, in a case where a 3C2B coating method is converted into a 3C1B coating method without changing the coating materials, due to the step of drying (baking) the intermediate coating film being omitted, the effect of reducing asperities (convexities and concavities that are visible on the coating film surface) on the surface of the intermediate coating film during drying, which has conventionally been achieved, is no longer obtainable. Describing in more detail with reference to the drawings, as shown in FIG. 2A, asperities is typically found on the surface of the intermediate coating film immediately after the application of the intermediate coating material. By letting this rest for a predetermined period of time and setting, the asperities become less distinct (see FIG. 2B). Then, this asperities become even less distinct during curing at elevated temperatures, whereby the convexities and concavities on the coating surface are reduced and become level for an improved finish appearance (see FIG. 2C). Due to there being no such step of drying the intermediate coating film, the 3C1B coating method fails to provide the effect of reducing asperities and thus the finish appearance is deteriorated. Although a means for improving the surface fluidity of the intermediate coating film during setting after application of the intermediate coating material has been considered as a means to solve this, due to the viscosity of the coating film decreasing during heating in the case of applying this means, it cannot be said to be a preferable solution since mixing of the coating layers, as described later, is expected.

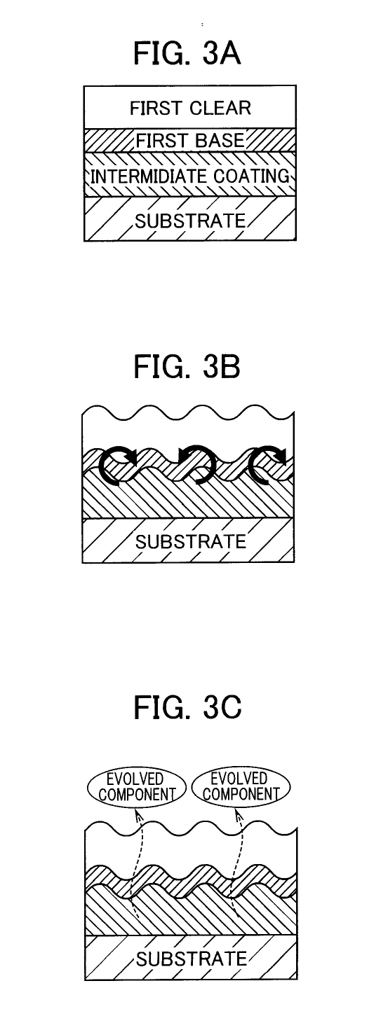

Secondly, one cause that can be given is that heating can cause a flow phenomenon between the coating films, whereby the coating layers are mixed to impair the finished appearance. In more detail, conventional intermediate coating materials typically employ a crosslinking agent such as of melamine resin, blocked isocyanate, similarly to base top coating materials and clear top coating materials. The conventional intermediate coating materials thus have a curing start temperature close to those of the base top coating materials and the clear top coating materials. Therefore, flow between the coating layers occurs in the step of heating since the coating films drop in viscosity before the start of curing (see FIG. 3B). The mixing of the coating layers attributed to the flow phenomenon leaves traces of flow as asperities on the topmost surface, and the finish appearance deteriorated. Although a means that increases the viscosity of the coating films at the time of heating so as to suppress the mixing during heating has been considered as a means to solve this, since the viscosity inevitably decreasing during setting as well in the case of applying this means, and thus is not a desirable solution since the surface fluidity of the coating film will drop during setting.

Thirdly, a cause that can be given is that, since a reducing component of low molecular weight, which is yielded from the curing reaction of the intermediate coating film, volatilizes during heating, shrinkage in the volume of the intermediate coating film occurs, whereby asperities are generated, and the finish appearance is deteriorated. In more detail, as mentioned above, since conventional intermediate coating materials employ a crosslinking agent such as melamine resin and blocked isocyanate, reaction evolved substances and the like are generated during the curing reaction when heated. Since the conventional intermediate coating films cause alcohol volatilization during heating, the intermediate coating films shrink in volume and produce asperities (see FIG. 3C). The asperities are then transferred to upper layers, deteriorating the finish appearance. Although the use of an intermediate coating material containing a crosslinking agent that produces no reaction evolved substances during the curing reaction has been considered as a means for solving this, such a material is not commonplace among the conventional intermediate coating materials.

Under the circumstances, the method for forming a multilayer coating film according to the present embodiment has been developed to avoid deterioration in the finish appearance attributed to the foregoing three causes. A specific means thereof is to use a two-package liquid coating material that employs an isocyanate compound as the crosslinking agent. Since a two-package liquid coating material employing an isocyanate compound as the crosslinking agent has hardly been used in the conventional 3C2B coating methods, the invention can be said to have been achieved based on a new technical idea.

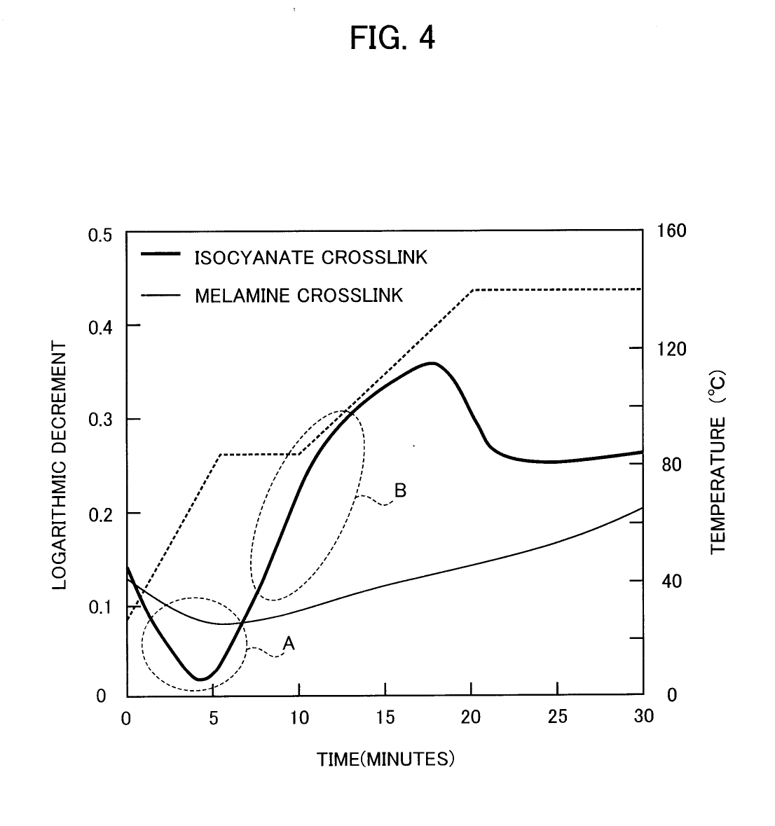

The mechanism of the method for forming a multilayer coating film according to the present embodiment will be described in detail with reference to FIG. 4. FIG. 4 is a chart showing changes in viscosity of multilayer coating films with time, in a case where a two-package liquid intermediate coating material employing an isocyanate compound as the crosslinking agent was wet-on coated with a water-based base top coating material (the present embodiment) and where a one-package liquid intermediate coating material containing melamine resin as the crosslinking agent was wet-on coated with a water-based base top coating material (conventional), respectively. The measurements were obtained by a pendulum type viscoelasticity measuring instrument (FDOM) “DDV-OPA III” from ORIENTEC Co., Ltd. As shown in FIG. 4, the multilayer coating film according to the present embodiment shows greater variations in the viscosity of the coating film in the course of temperature rise as compared to conventional multilayer coating film. More specifically, the multilayer coating film according to the present embodiment drops greatly in viscosity once in the course of temperature rise up to 80° C. (see A in FIG. 4). This drop in viscosity is attributed to the melt viscosity of the intermediate coating film, and due to the drop in viscosity enhancing the surface fluidity of the coating film, the coating surface becomes level and provides for superior finish appearance. In the course of temperature rise from 80° C. to 140° C., the multilayer coating film sharply increases in viscosity, which is attributed to a sharp increase in the viscosity of the intermediate coating film with the progress of the isocyanate crosslinking reaction (see B in FIG. 4). The sharp increase in the viscosity of the coating film can prevent mixing with the clear top coating film.

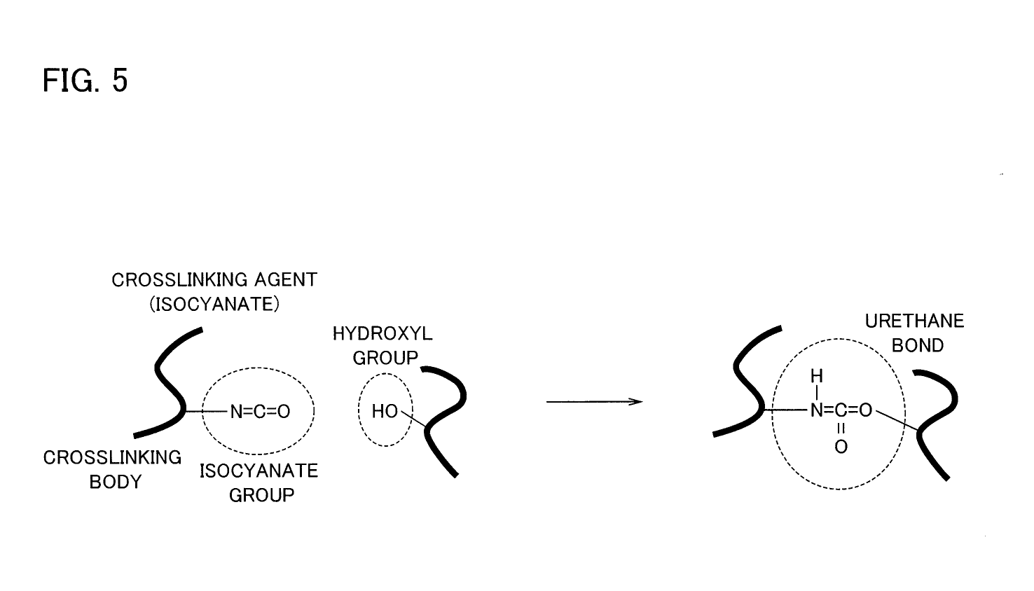

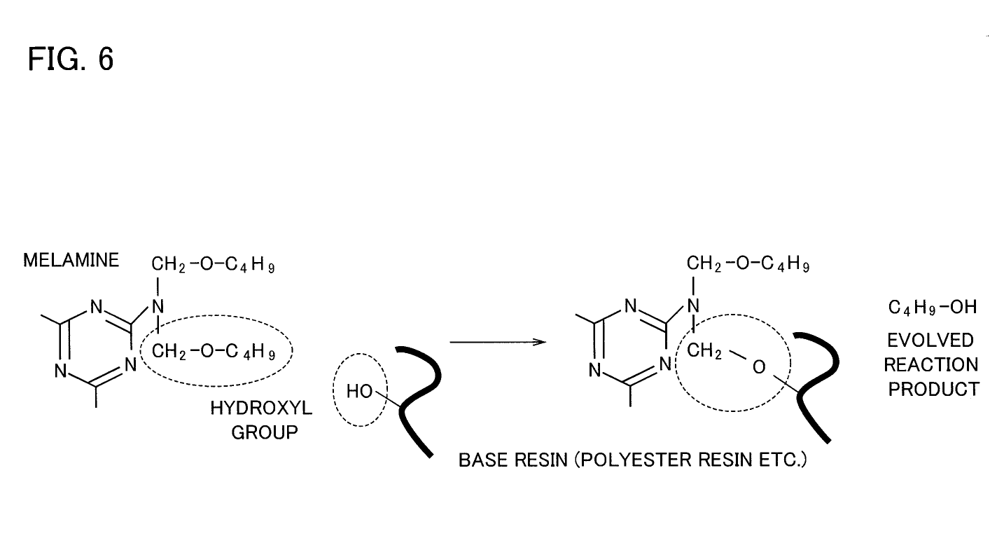

As described above, the crosslinking reaction of conventional intermediate coating film involves evolution of alcohol as a reaction product and volatilization thereof (see FIG. 6). In contrast, the intermediate coating film according to the present embodiment is a two-package liquid coating material employing an isocyanate compound as the crosslinking agent, and thus will not produce any reaction product such as alcohol (see FIG. 5). As a result, shrinkage in the volume of the intermediate coating film does not occur during heating as well, and Thus superior finish appearance is believed to be provided.

It should be noted that the isocyanate compound may be conventionally known compounds and is not particularly limited. For example, alicyclic, aromatic-containing aliphatic, or aromatic multifunctional isocyanate compounds may be used, and diisocyanates or isocyanurates (diisocyanate trimers) are preferably used.

Diisocyanates with a number of carbon atoms of 5 to 24, or preferably 6 to 18, may be used. Such diisocyanates include, for example, trimethylene diisocyanate, tetramethylene diisocyanate, hexamethylene diisocyanate, 1,6-diisocyanatohexane (HDI), 2,2,4-trimethylhexane diisocyanate, undecane diisocyanate-(1,11), lysine ester diisocyanate, cyclohexane 1,3- and 1,4-diisocyanate, 1-isocyanate-3-isocyanatomethyl-3,5,5-trimethylcyclohexane (IPDI), 4,4′-diisocyanatodicyclomethane, ω,ω′-dipropyl ether diisocyanate, thiodipropyl diisocyanate, cyclohexyl-1,4-diisocyanate, dicyclohexylmethane-4,4′-diisocyanate, 1,5-dimethyl-2,4-bis(isocyanatomethyl)benzene, 1,5-trimethyl-2,4-bis(ω-isocyanatoethyl)-benzene, 1,3,5-trimethyl-2,4-bis(isocyanatomethyl)benzene, 1,3,5-triethyl-2,4-bis(isocyanatomethyl)benzene, dicyclohexyldimethylmethane-4,4′-diisocyanate, 2,4-toluene diisocyanate, 2,6-toluene diisocyanate, and diphenylmethane-4,4′-diisocyanate. Aromatic diisocyanates may also be used, including 2,4-diisocyanatotoluene and/or 2,6-diisocyanatotoluene, 4,4′-diisocyanatodiphenylmethane, 1,4-diisocyanatoisopropylbenzene, cyclohexyl-1,4-diisocyanate, toluene diisocyanate, and hexamethylene diisocyanate. Furthermore, the diisocyanate trimers mentioned above can be exemplified as the isocyanurate. The multifunctional isocyanate compounds may be used alone or in a combination of two or more types. A mixture of the diisocyanates and isocyanurates (trimers) may also be used. The isocyanate compounds are not limited to any particular molecular weight.

The base resin is not particularly limited as long as it causes a crosslinking reaction with an isocyanate compound and, although a conventionally known one may be used, hydroxyl-containing resins are ideally used. The hydroxyl-containing resins are not particularly limited as long as polymers contain hydroxyl groups, for example, hydroxyl-containing acrylic copolymers, hydroxyl-containing polyester copolymers, hydroxyl-containing alkyd resins, hydroxyl-containing silicone resins and the like can be exemplified as the hydroxyl-containing resins. These hydroxyl-containing resins may further contain a carboxyl group, epoxy group, etc. The base resin is also not limited to any particular molecular weight.

The intermediate coating material may also contain a curing catalyst for promoting the isocyanate crosslinking reaction. More specifically, an organic tin compound curing catalysts such as dibutyltin dilaurate, dibutyltin diacetate, and dibutyltin dioctate may be contained. As a result, the crosslinking reaction proceeds to some extent at room temperature without providing a preheating step, and due to it being possible to avoid mixing of the upper layers by an increase in the viscosity of the intermediate coating film, the finish appearance can be improved.

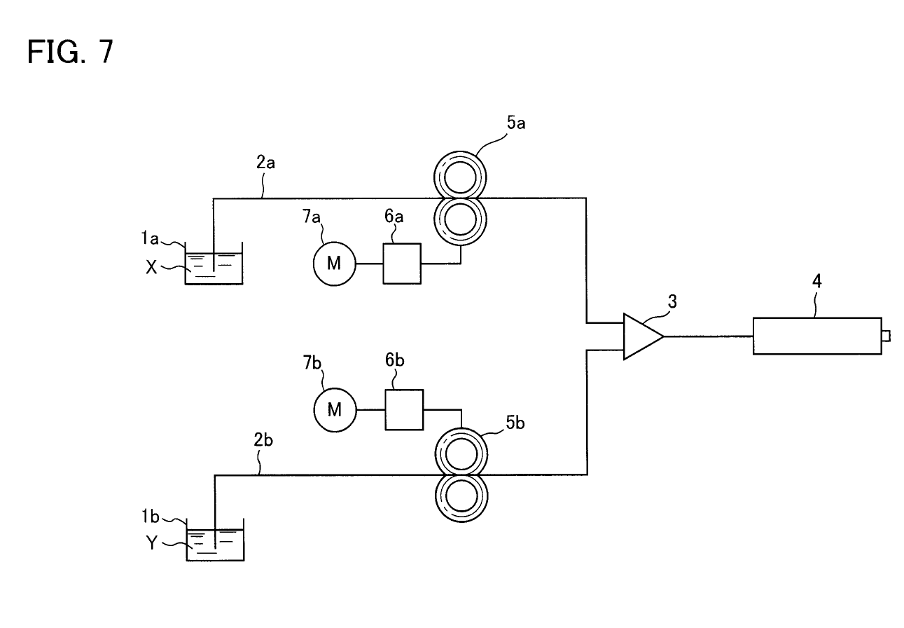

The crosslinking agent employing an isocyanate compound and the base resin can be mixed and applied by using a conventionally known mixing and coating apparatus, such as the two-packagee liquid mixing type coating apparatus disclosed in Japanese Utility Model Registration Publication No. 2506381. FIG. 7 shows a schematic block diagram of the two-package liquid mixing type coating apparatus. As shown in FIG. 7, the two-package liquid mixing type coating apparatus has reservoir tanks 1a and 1b for storing a base (base resin) X and a crosslinking agent (isocyanate compound) Y, to which respective feed channels 2a and 2b are disposed at one end thereof, respectively. The other ends of the feed channels 2a and 2b are connected to inlets of a mixer 3, while a spray gun 4 is connected to the outlet side of the mixer 3. Gear pumps 5a and 5b are arranged in the middle of the feed channels 2a and 2b, respectively, and the gear pump 5a is coupled with a pneumatic motor 7a via a transmission 6a, and the gear pump 5b is coupled with a pneumatic motor 7b via a transmission 6b. Reduction gears may be provided in place of these transmissions.

With such a configuration, the number of revolutions of the gear pumps 5a and 5b are adjusted by the transmissions 6a and 6b in order to set the mixing ratio between the base X and the crosslinking agent Y. The pneumatic motors 7a and 7b are then driven at a predetermined number of revolutions and, by the driving operation of the gear pumps 5a and 5b, the base X and the crosslinking agent Y are discharged from the reservoir tanks 1a and 1b to the mixer 3 at predetermined flow rates. The base X and the crosslinking agent Y are then mixed in the mixer 3, supplied to the spray gun 4, and discharged from the spray gun 4 to an article to be coated, not shown.

### Anti-Chipping Primer

In the step of applying an intermediate coating material according to the present embodiment, an anti-chipping primer may be applied (not shown) before the application of the intermediate coating material. The anti-chipping primer is intended to protect the coating films by absorbing impact from stones and the like that are kicked up by moving vehicles, and is typically applied in outer panel coatings of a vehicle. The anti-chipping primer is applied before the application of the intermediate coating, in the same or a different coating booth as with the intermediate coating. The coating is carried out manually or by an automated machine and, although the application range is determined depending on the shape of the vehicle, it typically includes locations that are vulnerable to stone chipping.

The anti-chipping primer is not limited to any particular material, and both water-based and organic solvent-based ones may be used. For example, a crosslinking type that employs a crosslinking agent and non-crosslinking type that does not employ a crosslinking agent may be used in which polyolefin resin, polyester resin, polyurethane resin, or the like is the primary component. It should be noted that preheating may be conducted after anti-chipping primer coating.

### Step of First Preheating

The method for forming a multilayer coating film according to the present embodiment preferably includes a first preheating step in which the article to be coated that has undergone the intermediate coating material application step is preheated. A conventionally known means such as hot air (flashing-off by blowing hot air at high speed, etc.) and infrared heating may be used as the preheating means. The heating conditions for the preheating are set as appropriate according to the composition of the intermediate coating material. More specifically, the heating conditions are set to reduce the viscosity of the intermediate coating film so that the intermediate coating film has favorable surface fluidity. More specifically, for example, a heating duration of 3 to 30 minutes at a heating temperature of 40° C. to 100° C. can be exemplified as heating conditions.

In a case of heating temperatures below 40° C., since the solvent in the intermediate coating film will not volatilize sufficiently, the intermediate coating film will mix with a first base top coating film during the application of the first base top coating to be described later, whereby the finish appearance will deteriorate. On the other hand, at a heating temperature above 100° C., the intermediate coating film will cure completely, and fluidity after the first base top coating cannot be attained, thereby deteriorating the finish appearance. In addition, high temperature ovens have such equipment requirements as heat resistance, which increases the amount of investment and hinders the cost efficiency due to adding to the energy cost of heating. Moreover, after the first preheating, the article to be coated needs to be cooled down to near room temperature for the subsequent first base top coating; however, time is required to cool down from above 100° C., which makes the process longer.

In the case of heating durations of less than 3 minutes, since the solvent in the intermediate coating film will not volatilize sufficiently and the intermediate coating film does not significantly cure, when the first base top coating is applied, the intermediate coating film absorbs the solvent in the base top coating film, whereby finish appearance is deteriorated. On the other hand, in the case of heating durations beyond 30 minutes, the intermediate coating film cures completely, and fluidity after the first base top coating cannot be obtained, resulting in deteriorated finish appearance. In addition, since ordinary ovens take 30 minutes or more, a process-shortening effect cannot be achieved from ovens taking longer than this. The increased amount of investment and the increased energy cost for heating also impair the cost efficiency.

The first preheating step improves the surface fluidity of the intermediate coating film and reduces asperities on the surface of the intermediate coating film. As a result, by providing the first preheating step, a coated article of superior finish appearance can be obtained.

### Step of Applying First Base Top Coating Material

The first base top coating material to be used in this step may be the same as ones that have been conventionally used as a base top coating material, and is not particularly limited. In addition, both water-based and organic solvent-based materials may be used. Mixtures of such base resins as alkyd resin, polyester resin, acrylic resin, and epoxy resin, and such curing (crosslinking) resins as amino resin, polyisocyanate resin, and carboxylic resin, for example, can be exemplified as the resin component to be contained in the first base top coating material.

The first base top coating material used in the present embodiment may contain a lustrous pigment. Aluminum flakes, evaporated aluminum, color pigment coated aluminum flakes, metal oxide coated alumina flakes, metal oxide coated silica flakes, graphite pigments, metal oxide coated mica, titan flakes, stainless flakes, bismuth oxychloride, sheet-like iron oxide pigments, metal plated glass flakes, metal oxide coated glass flakes, and hologram pigments, for example, can be exemplified as the lustrous pigment. The lustrous pigments may be used alone or in combinations of two or more types.

The first base top coating material used in the present embodiment may contain a coloring pigment aside from the lustrous pigment. Titanium dioxide, carbon black, zinc flower, molybdenum red, Prussian blue, cobalt blue, phthalocyanine pigment, azo pigment, quinacridone pigment, isoindoline pigment, indanthrene pigments, and perylene pigments, for example, can be exemplified as the coloring pigment. These coloring pigments may be used alone or in combinations of two or more types.

### Step of Second Preheating

The method for forming a multilayer coating film according to the present embodiment preferably includes a second preheating step in which the article to be coated that has undergone the first base top coating material application step is preheated. A conventionally known means such as of hot air (such as flashing-off by blowing hot air at high speed) and infrared heating may be used a means for preheating. The heating conditions for the preheating are appropriately set in response to the compositions of the intermediate coating material and the first base top coating material. In more detail, the heating conditions are set to reduce the viscosity of the first base top coating film so that a first base top coating film has favorable surface fluidity. More specifically, for example, a heating duration of 3 to 30 minutes at a heating temperature of 40° C. to 100° C. can be exemplified as heating conditions.

In the case of heating temperatures below 40° C., since the intermediate coating film will not cure, the intermediate coating film will absorb the solvent in the first clear top coating film after the application of the first clear top coating to be described later, whereby the finish appearance will deteriorated. On the other hand, in the case of heating temperatures above 100° C., the intermediate coating film will cure completely, and fluidity after the first base top coating cannot be attained, thereby deteriorating the finish appearance. In addition, high temperature ovens have such equipment requirements as heat resistance, which increases the amount of investment and hinders the cost efficiency due to adding to the energy cost of heating. Furthermore, after the second preheating, the article to be coated needs to be cooled down to near room temperature for the subsequent first clear top coating; however, time is required to cool down from above 100° C., which makes the process longer.

In the case of heating durations of less than 3 minutes, since the solvent in the intermediate coating film will not volatilize sufficiently, and the intermediate coating film does not significantly cure, when the first clear top coating is applied, the intermediate coating film absorbs the solvent in the top coating film, whereby the finish appearance is deteriorated. On the other hand, in the case of heating durations beyond 30 minutes, the intermediate coating film will cure completely, and fluidity after the first clear top coating cannot be obtained, resulting in deteriorated finish appearance. In addition, since ordinary ovens take 30 minutes or more, a process-shortening effect cannot be achieved from ovens taking longer than this. Furthermore, an increased amount of investment and the increased energy cost for heating also impair the cost efficiency.

The second preheating step is to preheat the intermediate coating film and the first base top coating film without preventing the coating films from entering a semi-cured state. That is, the intermediate coating film and the first base top coating film may start curing before the application of the first clear top coating material. In this way, mixing with the first clear top coating film can be effectively avoided, and a coated article of superior finish appearance can be obtained.

### Step of Applying First Clear Top Coating Material

The first clear top coating material to be used in this step may be the same as ones that have been conventionally used as a clear top coating material, and is not particularly limited. Both water-based and organic solvent-based materials may be used. Mixtures of such base resins as alkyd resin, polyester resin, acrylic resin, epoxy resin, fluorine resin, and silicon containing resin, and such curing (crosslinking) resins as amino resin, polyisocyanate resin, and carboxylic resin, for example, can be exemplified as the resin component of the first clear top coating material.

### Step of First Drying

The present step is a step in which the intermediate coating film, the first base top coating film, and the first clear top coating film each of which is uncured or semi-cured, are completely cured. A conventionally known means such as hot air drying and infrared drying may be used as the drying means. The drying conditions are appropriately set in response to the compositions of the intermediate coating material, the first base top coating material, and the first clear top coating material. More specifically, for example, a heating duration of 15 to 60 minutes at a drying temperature of 120° C. to 170° C. can be exemplified.

### Auxiliary Material

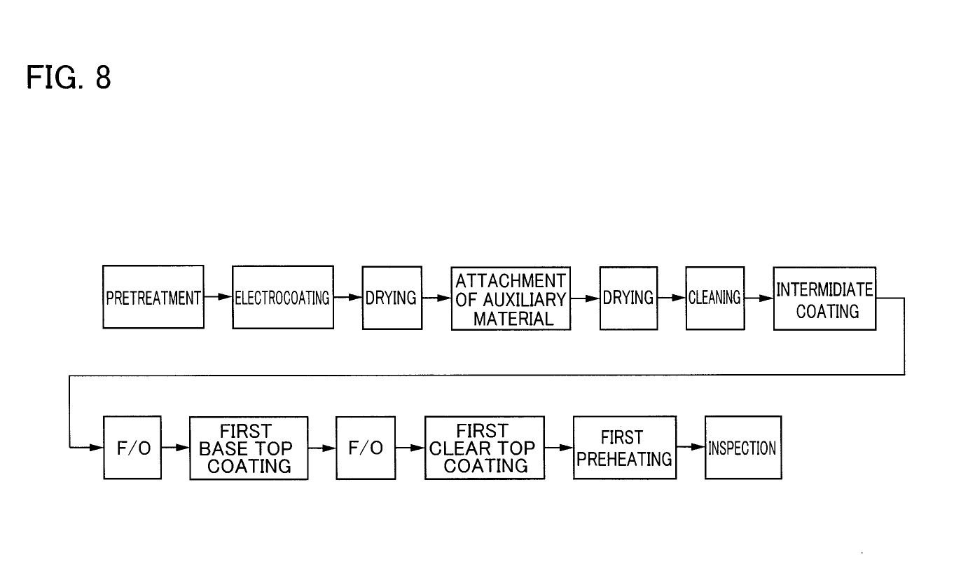

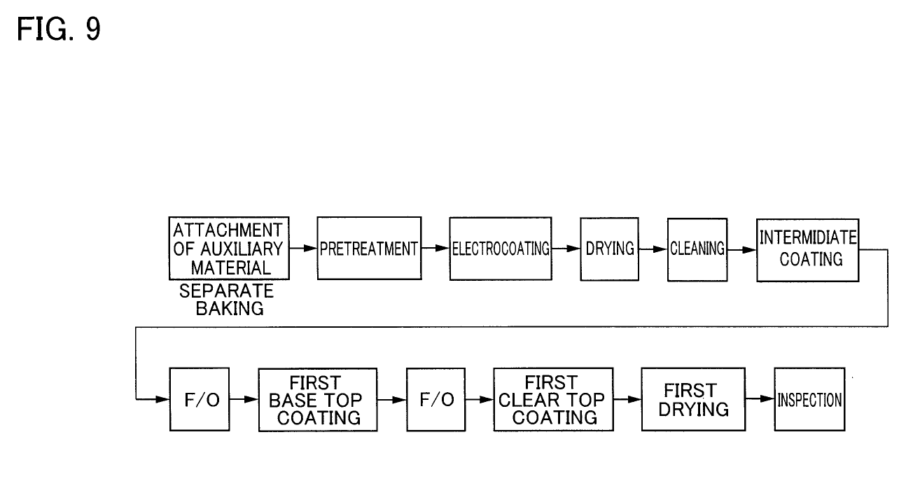

In the present embodiment, the step of attaching an auxiliary material may be provided between each of the coating steps described above (see FIGS. 8 to 11). As shown in FIGS. 9 to 11, the above-mentioned members with an auxiliary material (first auxiliary material) attached thereto, followed by the primer coating film, may be used as the article to be coated of the present embodiment. As employed in the present embodiment, the first auxiliary material indicates various types of high polymer materials that are attached to predetermined locations of the article to be coated (vehicle), other than coating materials. More specifically, for example, seals, grommets, insulation sheets, and undercoats can be exemplified.

Seals are intended to prevent penetration of water and outside air. Sealants are discharged from the nozzle of an applicator (discharger) or the like and filled into seams, hemmed portions, etc. of steel sheets so as to seal the locations. Semi-liquid polymers which dry and solidify can be used as the sealants, and are exemplified by, for example, acrylic vinyl sols and bituminous materials. Colored sealants are typically used, whereas transparent ones may be used in locations where appearance is an issue. When the sealants are discharged and attached, part of the sealants can viscously spread and adhere to a coating area. In addition, dust can also adhere thereto during operation.

Grommets are attached where through holes are formed in a steel sheet or the like (article to be coated) for wiring purposes, so as to prevent the cable claddings from being damaged by vibration and the like and developing a short circuit (fire). Conventionally known rubber grommets may be used. When these grommets are mounted, a portion of the grommets can be become dust and adhere to a coating area, whereby the adhering of dust can possibly occur during operation.

Insulation sheets are sheets having functions such as of insulating vibrations and noise, and are mounted at predetermined locations of the article (vehicle) to be coated. Bituminous or rubber insulation sheets may be used. The bituminous sheets are made of high polymer materials that fuse when heated and can be exemplified, for example, by asphalt. The bituminous sheets are also called fusible insulators, which are attached to the floor of a vehicle at the front right and front left of the front seats and the rear right and rear left of the front seats, the rear seats, the rear room floor, the dashboard, etc. When the insulation sheets are mounted, part of the insulation sheets can become dust and adhere to a coating area, and there is a possibility for dust to adhere during the operation.

Undercoats are formed by applying or spraying certain undercoating on the underside of the floor, the seams of steel sheets in wheel housings, etc. in order to improve waterproofing, dustproofing, rustproofing, and anti-chipping properties (damage prevention against stone chipping, and the like). For example, a material of similar material properties as the above-mentioned sealant can be exemplified as the undercoating material. When the undercoating is applied (formed), part of the undercoating may scatter and adhere to a coating area, and dust can also adhere during operation.

As shown in FIGS. 8, 10, and 11, for example, the step for attaching a second auxiliary material to the article to be coated may precede the intermediate coating material application step. The second auxiliary material is not particularly limited, and various auxiliary materials as exemplified in the description of the first auxiliary material may be used.

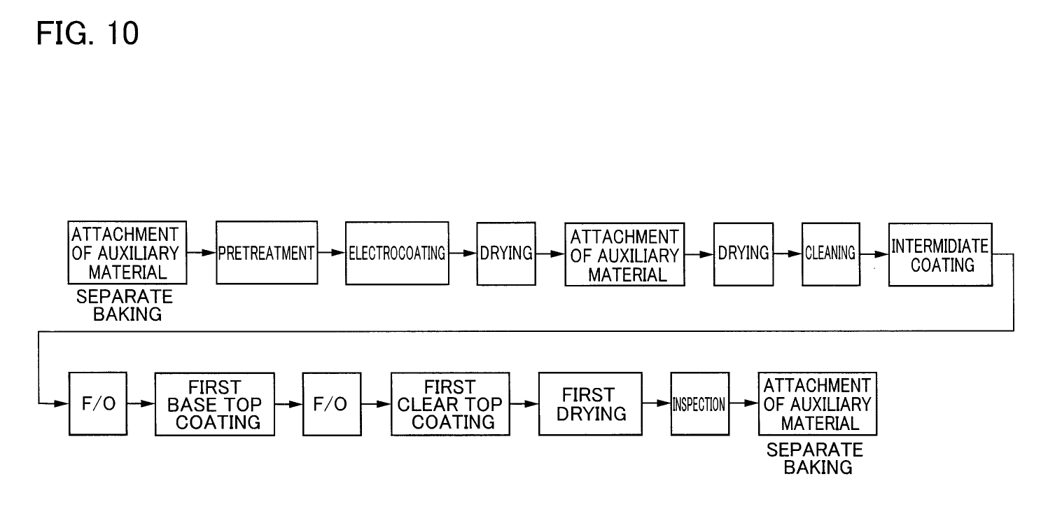

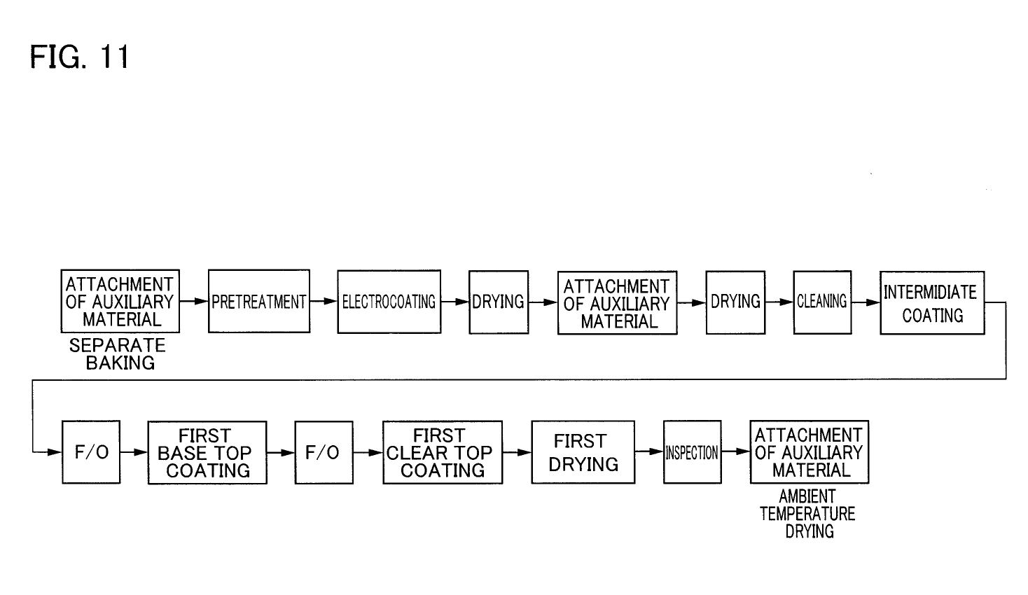

Alternatively, as shown in FIGS. 10 and 11, the first drying step may be followed by a step of attaching a third auxiliary material to the article to be coated that has undergone the first drying step. The third auxiliary material is not particularly limited, and various auxiliary materials as exemplified in the description of the first auxiliary material may be used.

As shown in FIGS. 8 to 11, drying (baking or cold drying) is performed separately if auxiliary materials are attached before and/or after the overall coating steps. If auxiliary materials are attached between the coating steps, on the other hand, since heated drying can be performed simultaneously with the preheating step of the coating films or with the first drying step, it is not necessary to perform drying separately, and is efficient. Alternatively, a cleaning step intended to remove dust and the like adhered to the surface of the article to be coated may be suitably provided between the coating steps if necessary.

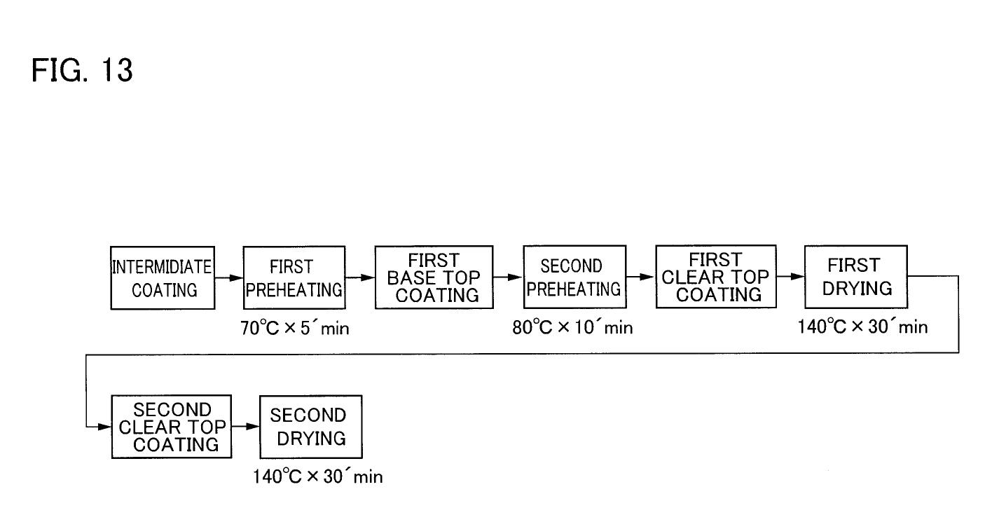

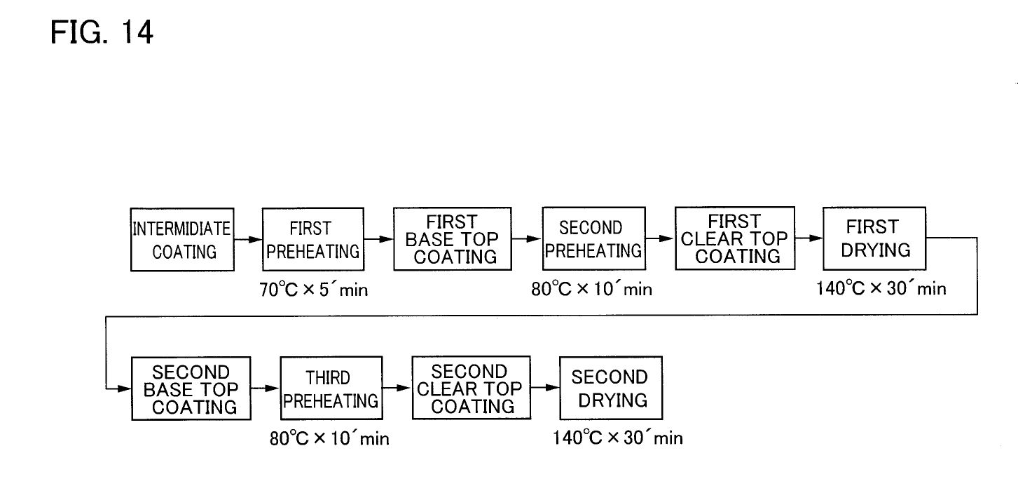

Next, a second embodiment and a third embodiment of the present invention will be described with reference to FIGS. 13 and 14.

The second embodiment and the third embodiment are described mainly by points of differences from the foregoing first embodiment, and similar points are assigned the same reference numerals, while descriptions thereof are omitted. Unless otherwise stated, the description of the first embodiment shall suitably apply.

As shown in FIG. 13, the method for forming a multilayer coating film and the method for manufacturing a coated article having a multilayer coating film according to the second embodiment are 4C2B methods for forming a multilayer coating film, including a second clear top coating material application step in which a second clear top coating material is applied and a second drying step in which the article to be coated that has undergone the second clear top coating material application step is dried after the 3C1B coating steps of the present invention. Hereinafter, a description is provided for the second clear top coating material application step and the second drying step.

### Step of Applying Second Clear Top Coating Material

This step is a step in which a second clear top coating material, such as a clear overcoating material in order to exude a sense of depth and high quality appearance, is applied to the article to be coated that has undergone the 3C1B steps.

The second clear top coating material to be used in this step may be the same as that used as the first clear top coating material, but is not particularly limited thereto.

### Step of Second Drying

This step is a step in which the second clear top coating film is completely cured. A conventionally known means such as hot air drying and infrared drying may be used as the drying means. The drying conditions are appropriately set according to the composition of the second clear top coating material. More specifically, for example, a heating duration of 15 to 60 minutes at a drying temperature of 120° C. to 170° C. can be exemplified as heating conditions.

Next, the third embodiment will be described. As shown in FIG. 14, the method for forming a multilayer coating film and the method for manufacturing a coated article having a multilayer coating film according to the third embodiment are 5C2B methods for forming a multilayer coating film that include, between the first heating step and the second clear top coating material application step according to the second embodiment, a second base top coating material application step in which a second base top coating material is applied and a third preheating step in which the article to be coated that has undergone the second base top coating material application step is preheated. Hereinafter, a description is provided for the second base top coating material application step and the third preheating step.

### Step of Applying Second Base Top Coating Material

This step is a step in which a second base top coating material, such as a colored transparent base for providing high color saturation and a high impression of shading, is applied onto the article to be coated that has undergone the 3C1B steps.

The second base top coating material to be used in this step may be the same as those used in the first base top coating material, but is not particularly limited thereto.

### Step of Third Preheating

The third embodiment preferably includes a third preheating step in which the article to be coated that has undergone the second base top coating material application step is preheated. A conventionally known means, such as hot air (such as flash-off by blowing hot air at high speed) and infrared heating may be used as a means for preheating. The heating conditions for the preheating are appropriately set according to the composition of the second base top coating material. In more detail, the heating conditions are set to reduce the viscosity of the second base top coating film so that the second base top coating film has favorable surface fluidity. More specifically, for example, a heating duration of 3 to 30 minutes at a heating temperature of 40° C. to 100° C. can be exemplified as heating conditions.

In the case of heating temperatures below 40° C., the second base coating material and the second clear coating material may mix, whereby the finish appearance will deteriorate. On the other hand, in the case of heating temperatures exceeding 100° C., fluidity after the second base top coating cannot be obtained, thereby deteriorating the finish appearance. In addition, high temperature ovens have such equipment requirements as heat resistance, which increases the amount of investment and hinders the cost efficiency due to adding to the energy cost of heating. Moreover, since CO₂ emission also increases unfavorably, it is also unfavorable from the view point of protection of the global environment. Furthermore, the article to be coated needs to be cooled down to near room temperatures after the third preheating for the second clear top coating; however, time is required to cool down from above 100° C., which makes the process longer.

In the case of heating durations less than 3 minutes, since the second base coating material and the second clear coating material will mix, the finish appearance is deteriorated. On the other hand, in the case of heating durations above 30 minutes, fluidity after the second clear top coating is not obtained, resulting in deteriorated finish appearance. In addition, since ordinary ovens take 30 minutes or more, a process-shortening effect cannot be achieved from ovens taking longer than this. Furthermore, the increased amount of investment and the increased energy cost for heating also impair the cost efficiency.

The third preheating step is to preheat the second base top coating film without preventing the second base top coating film from entering a semi-cured state. That is, the second base top coating film may start curing before the application of the second clear top coating material. In this way, mixing with the second clear top coating film can be effectively avoided, whereby a coated article of superior finish appearance is obtained.

In the third embodiment, the third preheating step is followed by the second base top coating material application step and the second drying step through which a multilayer coating film is formed as in the foregoing second embodiment.

The foregoing 4C2B and 5C2B methods for forming a multilayer coating film are based on the 3C1B coating steps of the present invention, and are intended to apply the second clear top coating material in order to exude a sense of depth and high quality appearance (4C2B), or apply the second base top coating material in order to exude high color saturation and a high impression of shading (5C2B). These methods are used primarily for producing luxury cars. The 3C1B method for forming a multilayer coating film, on the other hand, is used primarily for producing regular cars.

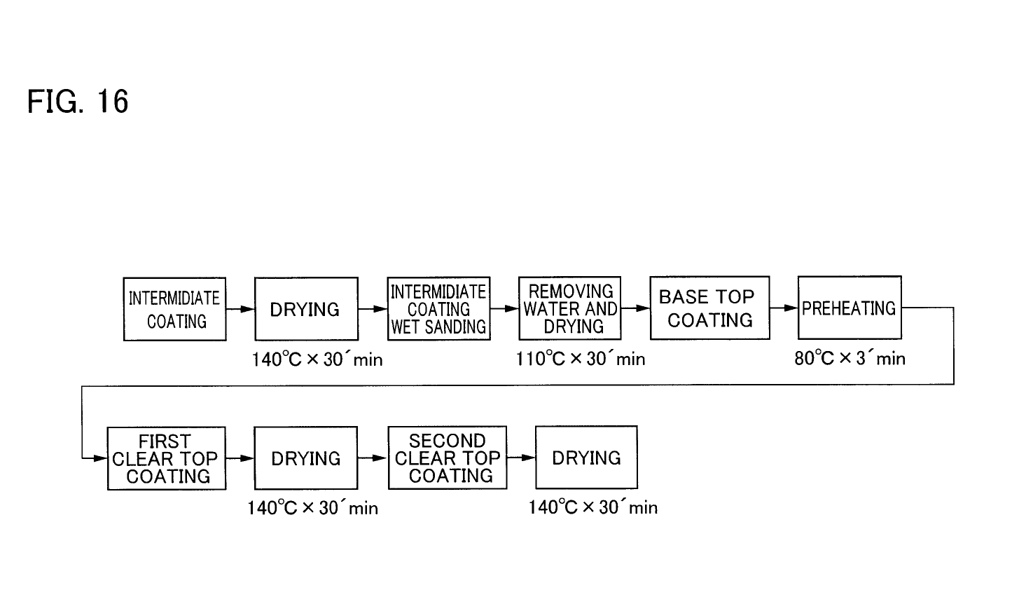

For forming such a multilayer coating film of high quality appearance, there have conventionally been known a 4C3B method (see FIG. 16) and a 5C3B method (not shown) in which additional layers of coating film are formed on the basis of the 3C2B coating steps. With the 4C3B and 5C3B methods for forming a multilayer coating film, however, it has been necessary for favorable finish appearance to smooth the coating surface by a wet sanding step (see FIG. 16) after the intermediate coating application step and heat curing or after the first clear coating material application step and heat curing.

In contrast, according to the 4C2B and 5C2B methods for forming a multilayer coating film based on the 3C1B coating steps of the present invention, a coating surface of superior smoothness is formed by the 3C1B coating steps. This makes it possible to provide an extremely favorable finish appearance without the wet sanding step.

In addition, since the 4C2B and 5C2B methods for forming a multilayer coating film of the present invention do not require the wet sanding step, it is possible to reduce the number of steps, while energy consumption and the water used for the wet sanding step can also be reduced.

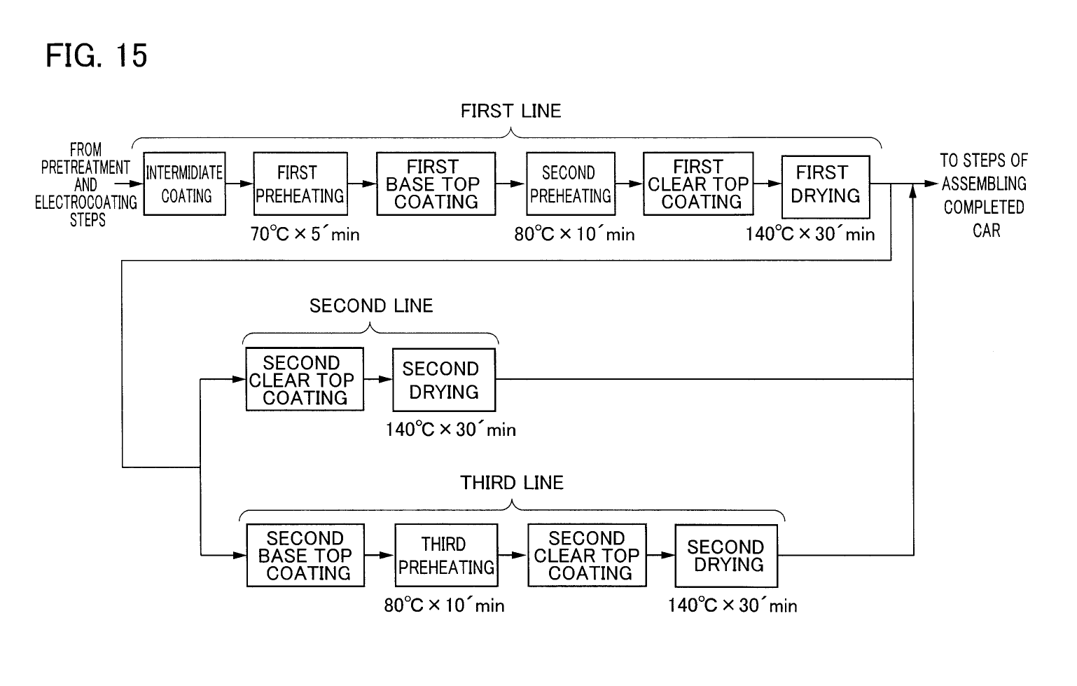

Next, a preferred embodiment of manufacturing facility for manufacturing a coated article using the method for forming a multilayer coating film of the present invention will be described with reference to FIG. 15.

In the present embodiment, as shown in FIG. 15, the coating facility includes a first line that covers the 3C1B coating steps, a second line that covers the second clear top coating material application step and the second drying step, and a third line that covers the second base top coating material application step, the third preheating step, the second clear top coating material application step, and the second drying step. In addition, a switching means (not shown) that is capable of switching the destination of a coated article that has passed through the first line is provided downstream from the first line. In the present embodiment, this switching means makes it possible to produce three types of coated articles according to demand, including coated articles that have passed through the first line alone (3C1B), coated articles through the first and second lines (4C2B), and coated articles through the first and third lines (5C2B).

In this way, for example, the coating facilities of the present embodiment can be applied to a vehicle body manufacturing facility to allow for mixed production of many models so that a plurality of models of vehicles ranging from regular models to be produced by the 3C1B coating method to luxury models to be produced by the 4C2B or 5C2B coating method are produced in a single plant.

In addition, since the coating facilities are composed of three separate lines, it is possible to independently perform maintenance on the first line, the second line, and the third line, respectively. In this way, for example, the second line and the third line for luxury models can be subjected to intensive quality control to produce products of even higher quality.

The coating facility according to the present embodiment includes three lines such as the first line, the second line, and the third line, whereas the manufacturing facilities may be composed of two lines such as the first line and the third line. In this case, the 4C2B coating steps can be implemented by skipping the second base top coating material application step and the third preheating step on the third line and bringing the second clear top coating material application step and the second drying step into operation.

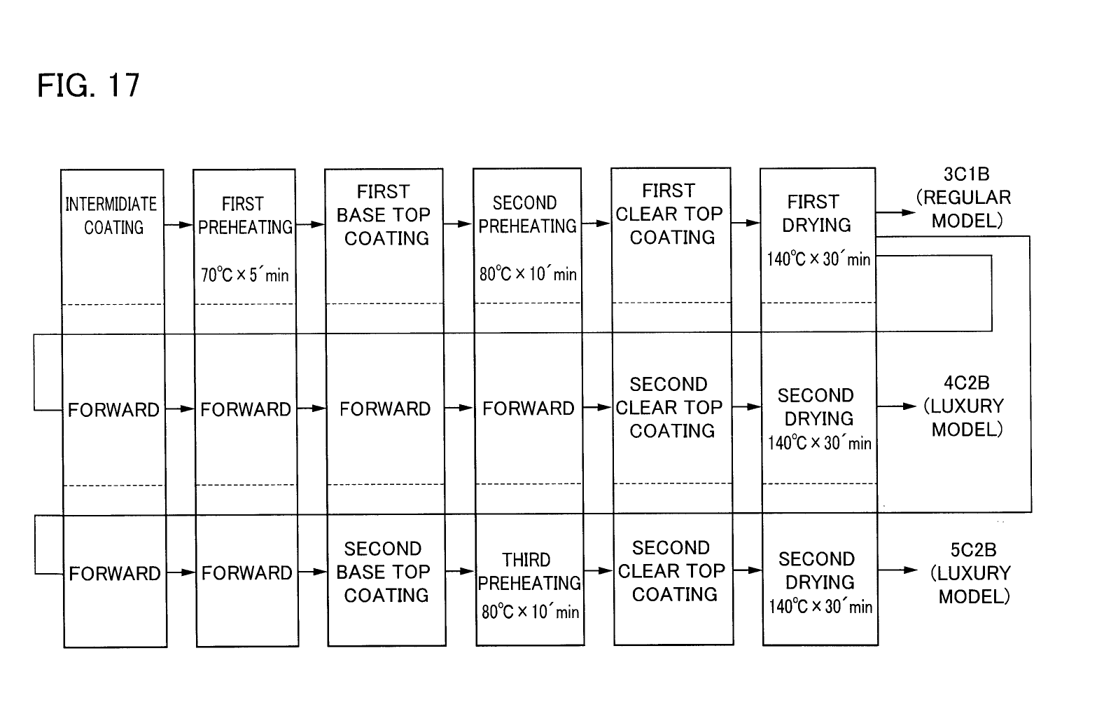

The coating facility may be composed of the first line alone (see FIG. 17). In this case, the 4C2B and 5C2B coating steps can be implemented by subjecting the articles twice to the first line. More specifically, when implementing the 4C2B coating steps, articles to be coated that have undergone the first drying step of the first line for the first time are put into the first line again, and for the second time, the intermediate coating material application step, the first preheating step, the first top coating material application step, and the second preheating step are skipped, and the first clear top coating material application step and the first drying step are operated as the second clear top coating material application step and the second drying step, respectively.

When implementing the 5C2B coating steps, articles to be coated that have undergone the first drying step of the first line for the first time are put into the first line again, and for the second time, the intermediate coating material application step and the first preheating step are skipped, and the first top coating material application step, the second preheating step, the first clear top coating material application step, and the first drying step are operated as the second top coating material application step, the third preheating step, the second clear top coating material application step, and the second drying step, respectively. In this way, the number of lines that constitute the coating facility can be reduced and, by using the existing line(s) a plurality of times, the cost can be reduced for implementing a coating facility capable of mixed production of many models.

The coated articles to be manufactured according to the present invention are not limited to the outer panels of a two-wheel and four-wheel vehicle, but may be components and the like that are used in ATVs (All Terrain Vehicles), air planes, ships, etc.

### EXAMPLES

Next, although the present invention will be described in further detail based on examples, the present invention is not limited thereto.

### Example 1

For Example 1, 3C1B coating was performed according to the procedure shown in FIG. 1, using a two-package liquid intermediate coating material containing an isocyanate compound as the crosslinking agent. More specifically, a cold rolled steel sheet (although even a galvanized steel sheet, electro-galvanized steel sheet, aluminum steel sheet, etc. can be considered, this test does not include specification for the type of base steel) was electrocoated with a cationic electrocoating material “HG350E” from Kansai Paint Co., Ltd., and baked at 170° C. for 20 minutes. Next, an intermediate coating material “KP30” from Kansai Paint Co., Ltd. was applied, followed by preheating at 70° C. for 5 minutes. A base top coating material “WT700” from Kansai Paint Co., Ltd. was then applied, followed by preheating at 80° C. for 10 minutes. Finally, a clear top coating material “KINO #430” from Kansai Paint Co., Ltd. was applied, and baked at 140° C. for 30 minutes.

### Example 2

For Example 2, 4C2B coating was performed according to the procedure shown in FIG. 13, using a two-package liquid intermediate coating material containing an isocyanate compound as the crosslinking agent. More specifically, after the 3C1B coating steps shown in Example 1, the clear top coating material “KINO #430” from Kansai Paint Co., Ltd. was applied as the second clear top coating material, and baked at 140° C. for 30 minutes.

### Comparative Example 1

For Comparative Example 1, 3C2B coating was performed according to the procedure shown in FIG. 12, using a one-package liquid intermediate coating material containing a melamine resin as the crosslinking agent. More specifically, a cold rolled steel sheet was electrocoated with the cationic electrocoating material “HG350E” from Kansai Paint Co., Ltd., and baked at 170° C. for 20 minutes. Next, an intermediate coating material “WP404” from Kansai Paint Co., Ltd. was applied and baked at 140° C. for 30 minutes. The base top coating material “WT700” from Kansai Paint Co., Ltd. was then applied, followed by preheating at 80° C. for 10 minutes. Finally, the clear top coating material “KINO #430” from Kansai Paint Co., Ltd. was applied and baked at 140° C. for 30 minutes.

### Comparative Example 2

For Comparative Example 2, 3C1B coating was performed according to the procedure shown in FIG. 1, using a one-package liquid intermediate coating material containing a melamine resin as the crosslinking agent. More specifically, a cold rolled steel sheet was electrocoated with the cationic electrocoacing material “HG350E” from Kansai Paint Co., Ltd., and baked at 170° C. for 20 minutes. Next, the intermediate coating material “WP404” from Kansai Paint Co., Ltd. was applied, followed by preheating at 70° C. for 5 minutes. The base top coating material “WT700” from Kansai Paint Co., Ltd. was then applied, followed by preheating at 80° C. for 10 minutes. Finally, the clear top coating material “KINO #430” from Kansai Paint Co., Ltd. was applied, and baked at 140° C. for 30 minutes.

### Comparative Example 3

For Comparative Example 3, 4C3B coating was performed according to the procedure shown in FIG. 16, using a one-package liquid intermediate coating material containing a melamine resin as the crosslinking agent. More specifically, a cold rolled steel sheet was electrocoated with the cationic electrocoating material “HG350E” from Kansai Paint Co., Ltd., and baked at 170° C. for 20 minutes. Next, the intermediate coating material “WP404” from Kansai Paint Co., Ltd. was applied and, after baking at 140° C. for 30 minutes, wet sanding was performed, followed by removing the water, and drying at 110° C. for 30 minutes. Next, the base top coating material “WT700” from Kansai Paint Co., Ltd. was applied, followed by preheating at 80° C. for 3 minutes, and then the clear top coating material “KINO #430” from Kansai Paint Co., Ltd. was applied as the first clear top coating material, and baked at 140° C. for 30 minutes. Finally, the clear top coating material “KINO #430” from Kansai Paint Co., Ltd. was applied as the second clear top coating material, and baked at 140° C. for 30 minutes.

### Evaluation

The multilayer coating films obtained in the examples and the comparatives examples were evaluated for finish appearance by using a finish characteristic value meter “wave scan” (from BYK-Gardner). More specifically, the multilayer coating films were measured for the amplitude of the asperities (dimples) in the surface of the coating film on a horizontal surface and a vertical surface, in long waves (LW wavelength: 1.2 mm to 12.0 mm) and short waves (SW wavelength: 0.3 mm to 1.2 mm) each. The results thereof are shown in Table 1.

As shown in Table 1, since the multilayer coating film formed by the 3C1B method of the present invention described in Example 1 showed smaller amplitudes under any conditions when compared to the multilayer coating film formed by the 3C2B method of Comparative Example 1 and the multilayer coating film formed by the 3C1B method of Comparative Example 2, it is confirmed to have a coating surface that is level and a favorable finish appearance.

In addition, since the multilayer coating film formed by the 4C2B method of the present invention described in Example 2 showed smaller amplitudes under any conditions when compared to the multilayer coating film formed by the 4C3B method of Comparative Example 2, it is confirmed to have a coating surface that is more level and a more preferable finish appearance. From the foregoing, it is confirmed that the present invention can provide a superior finish appearance to that of conventional wet-sanded multilayer coating films, even without a wet sanding step.

TABLE 1

| | | Finish Properties | | | |
|---|---|---|---|---|---|
| | | Horizontal | | Vertical | |
| | | LW | SW | LW | SW |
| Example 1 | 3C1B process | 1.5 | 16.0 | 4.4 | 17.3 |
| | isocyanate-crosslinked | | | | |
| | intermediate coating | | | | |
| Example 2 | 4C2B process | 1.3 | 5.7 | 2.9 | 8.7 |
| | isocyanate-crosslinked | | | | |
| | intermediate coating | | | | |
| Comparative | 3C2B process | 2.4 | 27.7 | 10.0 | 19.2 |
| Example 1 | melamine-crosslinked | | | | |
| | intermediate coating | | | | |
| Comparative | 3C1B process | 3.4 | 19.3 | 13.7 | 20.3 |
| Example 2 | melamine-crosslinked | | | | |
| | intermediate coating | | | | |
| Comparative | 4C3B process | 1.5 | 13.4 | 3.1 | 9.2 |
| Example 3 | melamine-crosslinked | | | | |
| | intermediate coating | | | | |

Finish properties value measurement device:
wave-scan (BYK-Gardner)
LW wavelength: 1.2 to 12 mm
SW wavelength: 0.3 to 1.2 mm
Smaller number values are more favorable

1. A method for forming a multilayer coating film, comprising:
a primer coating material coating step of coating a primer coating material onto an article to be coated;
an intermediate coating material application step of applying a two-package liquid intermediate coating material containing an isocyanate compound as a crosslinking agent onto the article to be coated that has undergone the primer coating material coating step;
a first base top coating material application step of applying a first base top coating material onto the article to be coated that has undergone the intermediate coating material application step;
a first clear top coating material application step of applying a first clear top coating material onto the article to be coated that has undergone the first base top coating material application step; and
a first drying step of drying the article to be coated that has undergone the first clear top coating material application step.

2. The method for forming a multilayer coating film according to claim 1, further comprising, between the intermediate coating material application step and the first base top coating material application step, a first preheating step of preheating the article to be coated that has undergone the intermediate coating material application step.

3. The method for forming a multilayer coating film according to claim 2, wherein the first preheating step is performed at a preheating temperature of higher than or equal to 40° C. and lower than or equal to 100° C.

4. The method for forming a multilayer coating film according to claim 1, further comprising, between the first base top coating material application step and the first clear top coating material application step, a second preheating step of preheating the article to be coated that has undergone the first base top coating material application step.

5. The method for forming a multilayer coating film according to claim 4, wherein the second preheating step is performed at a preheating temperature of higher than or equal to 40° C. and lower than or equal to 100° C.

6. The method for forming a multilayer coating film according to claim 1, further comprising: after the first drying step,
a second clear top coating material application step of applying a second clear top coating material; and
a second drying step of drying the article to be coated that has undergone the second clear top coating material application step.

7. The method for forming a multilayer coating film according to claim 6, further comprising: between the first drying step and the second clear top coating material application step,
a second base top coating material application step of applying a second base top coating material; and
a third preheating step of preheating the article to be coated that has undergone the second base top coating material application step.

8. The method for forming a multilayer coating film according to claim 7, wherein the third preheating step is performed at a preheating temperature of higher than or equal to 40° C. and lower than or equal to 100° C.

9. The method for forming a multilayer coating film according to claim 1, wherein an anti-chipping primer is applied in the intermediate coating material application step before the intermediate coating material is applied.

10. The method for forming a multilayer coating film according to claim 1, wherein an article to be coated that includes a first auxiliary material attached thereto is used as the article to be coated with the primer coating material.

11. The method for forming a multilayer coating film according to claim 1, further comprising, between the primer coating material coating step and the intermediate coating material application step, a step of attaching a second auxiliary material onto the article to be coated that has undergone the primer coating material coating step.

12. The method for forming a multilayer coating film according to claim 1, further comprising, after the first drying step, a step of attaching a third auxiliary material onto the article to be coated that has undergone the first drying step.

13. The method for forming a multilayer coating film according to claim 1, wherein a base and the crosslinking agent of the two-package liquid intermediate coating material containing the isocyanate compound as the crosslinking agent are mixed in the vicinity of a spray gun for spraying the intermediate coating material.

14. The method for forming a multilayer coating film according to claim 1, wherein the article to be coated is an outer panel of a vehicle body.

15. A method for manufacturing a coated article having a multilayer coating film formed thereon, comprising:
a primer coating material coating step of coating an article to be coated with a primer coating material;
an intermediate coating material application step of applying a two-package liquid intermediate coating material containing an isocyanate compound as a crosslinking agent onto the article to be coated that has undergone the primer coating material coating step;
a first base top coating material application step of applying a first base top coating material onto the article to be coated that has undergone the intermediate coating material application step;
a first clear top coating material application step of applying a first clear top coating material onto the article to be coated that has undergone the first base top coating material application step; and
a first drying step of drying the article to be coated that has undergone the first clear top coating material application step.

16. The method for manufacturing a coated article according to claim 15, further comprising:
a second clear top coating material application step of applying a second clear top coating material, after the first drying step; and
a second drying step of drying the article to be coated that has undergone the second clear top coating material application step.

17. The method for manufacturing a coated article according to claim 16, further comprising: between the first drying step and the second clear top coating material application step,
a second base top coating material application step of applying a second base top coating material; and
a third preheating step of preheating the article to be coated that has undergone the second base top coating material application step.

18. The method for manufacturing a coated article according to claim 15, wherein a base and the crosslinking agent of the two-package liquid intermediate coating material containing the isocyanate compound as the crosslinking agent are mixed in the vicinity of a spray gun for spraying the intermediate coating material.
